(19) United States
(12) Patent Application Publication
(10) Pub. No.: US 2010/0179907 A1
(43) Pub. Date: Jul. 15, 2010

(54) METHODS AND A SYSTEM FOR PROVIDING TRANSACTION RELATED INFORMATION

(76) Inventor: Steven Paul Atkinson, Surrey (GB)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/525,274

(22) PCT Filed: Jan. 30, 2008
(86) PCT No.: PCT/GB2008/050060

§ 371 Date: Mar. 19, 2010

(30) Foreign Application Priority Data
Feb. 1, 2007 (GB) 0701940.9

(51) Int. Cl. G06Q 20/00; H04W 4/24

(52) U.S. Cl. 705/44; 455/414.1; 705/39

(57) ABSTRACT

Methods and a system for providing a service enabling users to securely request and receive data representing details of a payment card using a mobile telephony device. The data representing details of a payment card can then be used to partake in a commercial transaction in which the user is not present at, or remotely located from, the point of transaction.

This invention relates to providing transaction related data. In particular, the invention relates to a method and system providing data representing details of a payment card for use in a transaction or verification process.

Due to the risk of fraud, consumers are uncomfortable in supplying payment card details (eg. credit, debit and prepaid card details) for use in commercial transactions, in particular where the cardholder is not present at the point of transaction. Whilst the level of electronic-commerce has grown, research has indicated that this growth has been slowed by consumers fearing fraud and their consequent reluctance to provide payment card details over the internet.

Furthermore, consumers who do not have debit or credit cards experience difficulty in completing remote transactions, such as over the internet or by phone, as they are unable to supply merchants with payment details to settle transactions.

It is therefore desirable to develop a method and/or system by which a consumer can complete a transaction, whilst reducing or minimising the exposure of their personal account or card details to the risk of fraud. It is also desirable to enable consumers who do not have debit or credit card to use such a method and/or system.

At present, it is known to provide data representing details of a payment card which can be used by consumers to complete transactions over the internet or the telephone. This data is otherwise known as card details, and typically comprises a 16-digit account number (Personal Account Number or PAN), an expiry date, a 3-digit security code (CVV2) and sometimes a start date.

Existing systems that provide such card details, other than from a card itself, include some which require a consumer to firstly register their personal details using the internet before they can receive a physical card via the post. Using this card, the consumer can then purchase vouchers of predetermined values from a retail outlet which are then accepted in cardholder-not-present (“CNP”) transactions (wherever the VISA™ logo is displayed). The vouchers are effectively prepaid disposable payment cards printed as a paper receipt rather than a plastic credit card. Consumers can use a voucher to make numerous CNP purchases as long as they do not exceed the available balance on the voucher. Unspent funds may be redeemed, however there is a fixed redemption fee and consumers must wait weeks or even months to receive the refund.

It will be appreciated that such existing systems are restricted to particular transactions and may be inconvenient since they require the user to purchase vouchers in advance of the transaction from a physical retail outlet.

### SUMMARY OF THE INVENTION

According to the invention, there is provided an electronic system providing data representing details of a payment card for use in a transaction, comprising a server having:
a first interface for communication with mobile telephony devices over a mobile telephone network; and
a second interface for communication with a card issuing system for issuing data representing details of a payment card in response to the communicated information,
wherein the first interface comprises:
   receiving means adapted to receive a request for the data representing details of a payment card from a user operating a mobile telephony device; and
   transmitting means adapted to provide the data representing details of a payment card to a mobile telephony device,
and wherein the second interface comprises:
   transmitting means adapted to transmit information to the card issuing system based on the request; and
   receiving means adapted to receive data representing details of a payment card from the card issuing system.

The invention also provides a method of requesting data representing details of a payment card for use in a transaction, the method comprising the steps of:
receiving a request for the data from a user operating a mobile telephony device, the user selecting options provided to the user by the mobile telephony device; and
processing the request and communicating information to an issuing system for issuing data representing details of a payment card in response to the data request.

According to another aspect of the invention, there is provided a method of generating data representing details of a payment card for use in a transaction, the method comprising the steps of:
receiving from an intermediary information comprising user data including mobile telephony identification data; and
generating data representing details of a payment card based on the user data.

According to yet another aspect of the invention, there is provided a method of supplying data representing details of a payment card for use in a transaction, the method comprising the steps of:
communicating the data from a card issuing system to a server having an interface for communication with a user telephony device over a mobile network; and
transmitting the data over the mobile telephony network to a user operating a mobile telephony device.

The invention allows consumers to shop remotely, via the internet, mail order or by telephone or at a Point of Sale (“POS”) terminal without having to divulge their actual debit or credit card details to the merchant. It therefore minimises the risk of fraud and may help consumers to overcome their reluctance to shop in such ways.

In addition to not disclosing the consumer's card details, the invention may further decrease the risk of fraud as the card details that are issued may be valid for a limited period of time and for a fixed amount. These limitations may be selected by the user.

The invention does not require the consumer to have a debit or credit card, or in fact any card-based bank account as card details can be generated from, and related to, user related information not requiring a normal payment card. The solution also enables cashpoint card holders (ie. cards that can be used in an ATM, to withdraw cash, but cannot be used as a debit card) to undertake electronic-commerce transactions.

The invention does not require the merchant to amend their policies, procedures or systems as the card details provided may be processed as a normal debit or credit card transaction.

### BRIEF DESCRIPTION OF THE DRAWINGS

Examples of the invention will now be described in detail with reference to the accompanying drawings, in which:

FIG. 1 shows a preferred registration procedure for a system of the invention;

FIG. 2 shows steps performed by a user to make a request for data representing details of a payment card;

FIG. 3 shows schematically an example of a system according to an embodiment of the invention; and

FIG. 4 shows four examples of different security layers present in the communication within a system according to the invention.

### DETAILED DESCRIPTION

The invention provides a method and a system for providing a service enabling users to securely request and receive data representing details of a payment card using a mobile telephony device. The data representing details of a payment card can then be used to partake in a commercial transaction, in particular where the user is not present at the point of transaction.

How a consumer gains access to the service and a how a consumer subsequently uses the service will now be described in the following sections. In the figures and following text, the term “mobileATM™” may be used, and this denotes a software implementation of the service/system of the invention. Of course, the service/system of the invention may be implemented using alternative software/hardware products.

User Registration

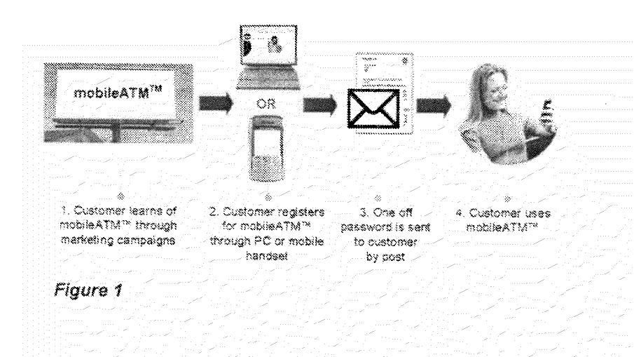

For security reasons it may be necessary for users to register for the service. This can be achieved in one of two ways; by registering via the service web site or registering for the service directly from a mobile phone. An overview of an exemplary registration process is given in FIG. 1, which shows how a user registers for the service.

FIG. 1 shows the four stages required to use the service. In stage 1, the user becomes aware of the existence of the service. In stage 2, there is a registration process, and the subsequent stage involves a password being sent to the user by post. This provides a link between the IP address or mobile identity of the user and the postal address, and thereby provides an additional level of security over the simple anonymous use of a PC or mobile telephone. After this registration process, in stage 4, the user is able to use the service.

Once registered, consumers can then begin to use the service and do so by navigating to an applications menu on their mobile phone device and executing a required application. In a similar fashion to logging into a secure service or a physical Automatic Teller Machine (ATM), the user is required to enter a numeric code, or Passcode, which forms part of an identification process.

Payment Card Details Request

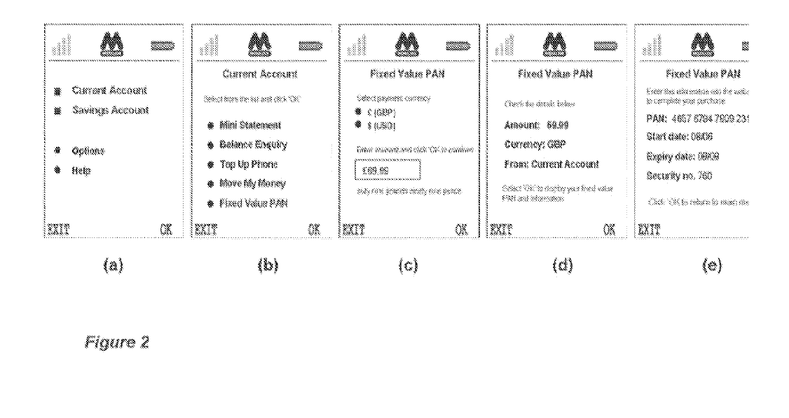

An overview of an exemplary process showing how a user may request payment card details is shown in FIG. 2. The five images in FIG. 2 show the following operations:
(a) The user selects an account from which they want the funds to be sourced.
(b) The user selects “Fixed Value PAN” from the service sub-menu.
(c) The user selects the desired currency type and then enters the amount required (the amount entered appears in both numerical values and words to decrease the risk of errors in manual keying). The user may also be provided with the option of selecting an expiry date (further decreasing the risk of fraud).
(d) The user is requested to check the details provided and confirm the request for card details by selecting OK. The request is communicated to a server which provides a card issuing system with the necessary details of the request that are required to issue card details. Purely by way of example, the details of the request may comprise: currency; amount; expiry date; and user details, thereby enabling the card issuing system to generate unique card details specifically for that user.
(e) Using the details from the request, the card issuing system generates some or all of the card details (i.e. 16-digit account number, start and end dates, and a 3-digit CVV2 security code) and transmits the details to the server. The server then encrypts and securely transmits the details to the user's mobile phone device upon which they are displayed.

The user may then use the details to represent a payment card and complete the payment stage of a transaction.

For the avoidance of any doubt, it should be understood that the above operation may be completed in a different order. For example, the order of steps (a) and (b) may be reversed.

When the user selects “OK” at each stage of the process, the information entered into the handset is encrypted and securely provided to the server and the next screen is displayed, requesting further input. In this way, the amount of processing undertaken by the mobile phone device can be reduced. In alternative embodiments, however, the amount of processing undertaken by the mobile phone device may depend upon the processing undertaken by the server. For example, the mobile phone device may be arranged to simply relay the user inputs to the server, therefore undertaking a minimal amount of processing. Conversely, the mobile phone device may complete numerous steps of processing on the inputs provided by the consumer, with only minimal processing being required by the server. Thus, a trade-off may be made between the mobile phone device and the server in terms of the processing requirements.

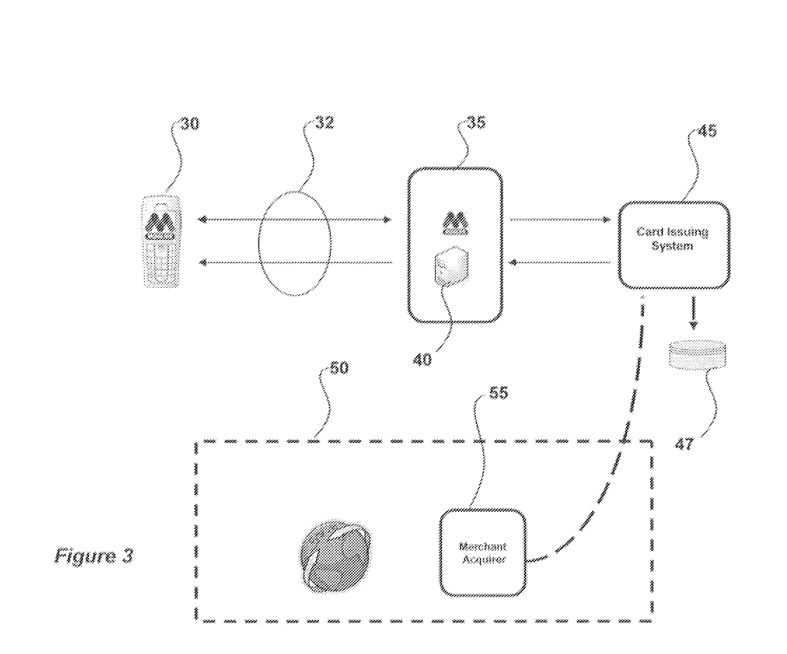

A description of a preferred implementation of the system of the invention now follows. A high level overview of such a system is shown in FIG. 3.
1. The user selects the mobileATM™ service/application on the mobile phone 30 and enters a Personal Identification Number (PIN) for security purposes. The PIN is encrypted and securely transmitted, via a mobile telephone network 32, to the Monitise server 35 for authentication. The user is individually identified and verified by the Monitise server using a database 40 which stores information relating to registered users. Such information may include; the identity of a user of a mobile telephony device; other contact details of the user of the mobile telephony device; details relating to the identity of the mobile telephony device (for example, the subscriber identification module (SIM) card identity or Mobile Station International Subscriber Directory Number (MSISDN)); a passcode provided by the user; card details for the user; and a bank account identifier set by a banking organisation.
2. The mobile phone 30 communicates with the Monitise server 35 and the user is led through a number of menu screens to request card details (as described above with reference to FIG. 2). The resultant request for card details provided by the user is transmitted to the server 35 using a secure communications protocol (in addition to the mobile network security level) and received by the server 35.
3. The server 35 provides a card issuing system 45 with details of the request so that the card issuing system 45 may generate card details that are unique to the request. Before generating the card details, the card issuing system 45 may communicate with a banking organisation 47 to request the required funds from the banking organisation. If the banking organisation 47 verifies the request is valid (i.e. verifies the requested funds are available), the card issuing system 45 continues with generating the requested card details.
4. Based upon the details provided in the request, the card issuing system 45 generates the card details (i.e. 16-digit account number, start and end dates, and a 3-digit CVV2 security code) and transmits the generated details to the server 35. The card issuing system may also transmit details including the amount and currency.
5. The server 35 then encrypts and securely transmits the card details (and possibly the amount and currency) to the user's mobile phone 30, via the mobile phone network 32, upon which they are displayed.
6. Upon receipt of the requested card details, the user may confirm safe receipt and cause the mobile phone 30 to transmit a confirmation message to the server 35, thereby terminating the session of the service/application.

The user can make use of the card details in a cardholder not present transaction. In such a transaction, the card details may be processed in the same way that details of an actual debit/credit card are processed. For example, in an electronic-commerce environment (as indicated generally by a dashed box 50), a user may provide the card details to a merchant 55 to complete payment for an item/service. In a similar way that existing card payment schemes are settled, the merchant 55 enquires with the card issuing system 45 which can then authorise and settle the payment with reference to the card details.

In alternative embodiments of the invention, the server 35 may be arranged to act as a gateway to banking records of at least one banking organisation. In this way, the server 35 may be used to authorise and settle payments with reference to the card details.

Further, as defined by an expiry date that may be included in the card details, the card details can be defined so that they are only valid for a predetermined time period. For example, whereas typical debit or credit cards are typically valid for a time period of 2 years, the card details may be defined to be valid for less than 1 year, less than 6 months, less than 1 month etc. In a preferable embodiment, the card details may be valid for less than 1 day. Most preferably, the user may specify the expiry date and/or time of the card details.

End to End Security Model

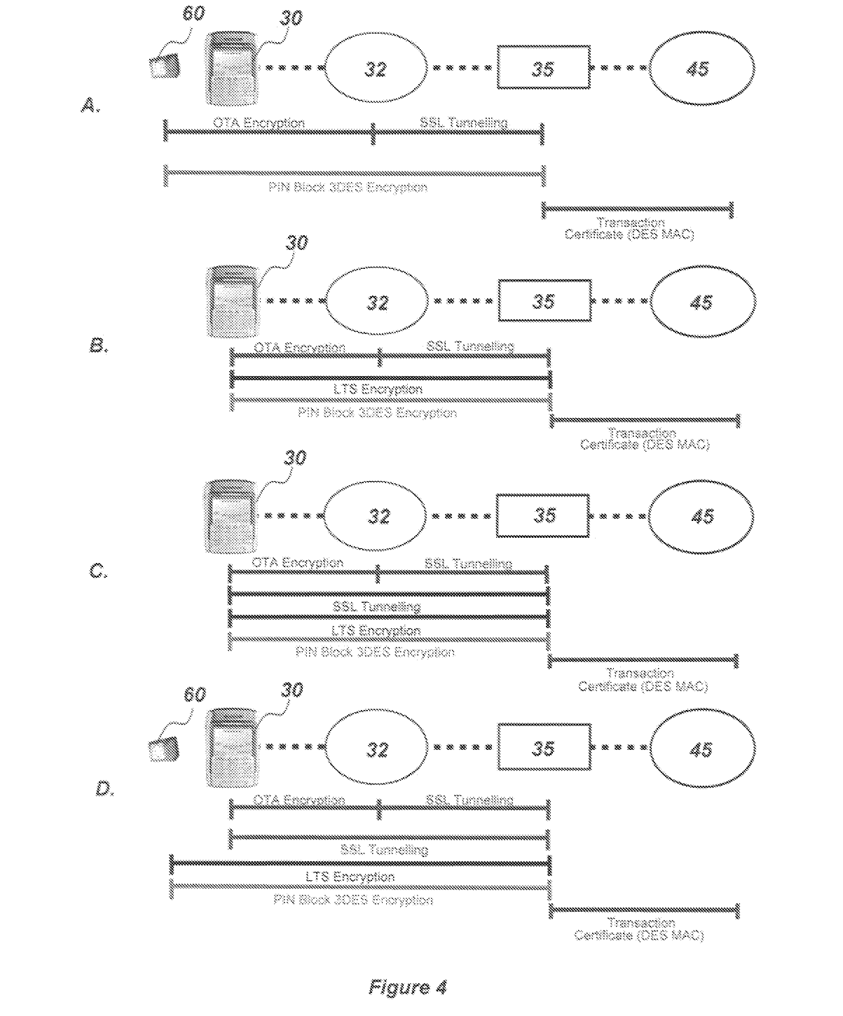

A primary design consideration for a system and/or service according to the invention is security. As shown in FIG. 4, the invention may employ a multi-layer security model.

In FIG. 4, part A is an overview of Multi-Layer Security Layer for a SIM Client which shows that network level security is provided by the encryption of over-the-air traffic from the SIM card 60 and the PIN encryption layer provides PIN Block 3DES level security for the PIN.

Part B is an overview of the Multi-Layer Security Model for a Mobile Information Device Protocol (MIDP) 1.0 Client, in which the security has been further improved to provide a mobileATM™ network level security in addition to the mobile network security level. This level provides a secure Secure Sockets Layer (SSL) like connection between the mobile phone application and the mobileATM™ server.

Part C is an overview of the Multi-Layer Security Model for a MIDP 2.0 Client, in which the network security has been further enhanced by providing an SSL tunnel directly from the handset to the mobileATM™ server. This model includes signed application code to address man-in-the-middle attacks.

Part D is a further enhancement for a MIDP 2.0 client with Java Specification Request (JSR) 177 Support. In this model, the encryption and decryption tasks are carried out within the SIM environment.

As shown in FIG. 4, different client types allow different types of security protection. However in each case there is OTA Encryption, SSL Tunneling and the PIN block encryption, which provides 3 DES PIN protection.

General security features of the service may include:
No customer bank card data is stored within the client application.
No customer bank card data is stored within the handset memory.
Not enough bank card information is held by mobileATM™ at the server side to clone a bank card or to perform a Card Not Present Transaction.
The customer selects their own Passcode
The Passcode secures the entire mobileATM™ channel.
The messaging protocol employed by mobileATM™ may be Hyper-Text Transfer Protocol (HTTP) request/response.

The LTS (Lightweight Transport Security) encryption layer may have the following attributes:
The LTS level encryption tunnel spans between the client application and the mobileATM™ server.
The LTS tunnel may prevent message insertion, removal, alteration or replay during transport between client and server.
The client and server contain custom encryption libraries to provide LTS level security.
The LTS public key is stored in the obfuscated client and can be 2048 bits in length.
The LTS pair key has a maximum life of 24 months.
Multiple LTS RSA key pairs can be active concurrently.

The PIN block encryption layer may have the following attributes:
Passcodes are associated with the mobileATM™ user ID to which they relate.
The Passcode offset value is an offset value from the Natural PIN generated from the customer ID using the mobileATM™ Private Encryption Key (PVK).
The customer entered Passcode value is not shown on the handset screen during entry.
The Passcode value held by mobileATM™ is stored within the mobileATM™ database as a PIN offset value protected by the mobileATM™ PVK.
The mobileATM™ PVK is double length DES key.
The user will be given five consecutive attempts to correctly enter their

Passcode into the client.
Each customer entered Passcode will be formed into an ISO Format-1 PIN block and encrypted with the mobileATM™ Working Key (WK) prior to transportation to the mobileATM™ server.
Following five consecutive incorrect Passcode entry attempts the mobileATM™ account for this customer will be locked. To gain access to the service the customer must request a new random key which is posted to their home address.
The mobileATM™ server uses a Thales RG8000 HSM (High Security Module—which is a standard banking security component) to verify the encrypted customer entered Passcode against the offset value stored in the mobileATM™ database.

### Advantages Provided by the Invention

The card details can be used to represent details of a payment card for making purchases over the internet, over the telephone, by mail order or at the point of sale for example. Thus, the invention allows consumers to shop in both a cardholder-not-present or cardholder present environment, without having to divulge their actual debit or credit card details and therefore helps to minimise the risk of fraud. Use of the service/system may be promoted by banks and merchants to minimise the risk of fraud and overcome consumers' reluctance to shop on-line.

In addition to not disclosing the consumer's card details, the invention may further decrease the risk of fraud as the card details that are issued may be valid for a limited period of time and for a fixed amount.

The invention can also enable consumers who do not have debit or credit cards to shop in a cardholder-not-present environment. This also benefits consumers that have “cashpoint cards”, which can be used to withdraw cash from ATMs but do not offer debit card functionality.

Users of the invention may be able to request card details and provide these to family or friends allowing them to make a purchase. The card details may be provided either as a gift or purely to facilitate a transaction where the recipient doesn't have access to a debit or credit card.

Features of the System

Notable features that may be provided by a system according to the invention include the following: [Dan, some of these are optional features]
A PIN or password is required to enter and use the system/service
A request for card details may be provided to server from a mobile phone via a secure and encrypted delivery method.
Card details can be provided to the user of a mobile phone via a secure and encrypted delivery method.
The user may select a value to exactly match the payment required, rather than an incremental fixed amount.
The user can select from a variety of currencies.
An expiry date can be selected by the user.
The transaction can be authorised and settled from the user's bank account or debit /credit card rather than prepaying an amount.
The user may select, in real time, an account to be used as a source of settlement, and this can be chosen depending on availability of funds.
The Card details can be generated from or be related to the sort code and account number of a non-card account (i.e. the system/service does not require the user to have a debit/credit card or any card-based bank account).
The system/service may not rely on prepayment of an amount prior to use of the card details.
The system/service enables real-time generation and delivery of card details anywhere and at any time which can then be used for payment within seconds
The risk of fraud can be reduced further by enabling the user to minimise the time within which the card details may be used and by nominating a fixed amount or value limit.
By dealing with consumers fears regarding fraud, the invention may help to reduce user reluctance to shop on-line, thereby leading to an increase in the level of e-commerce.
The invention does not require the merchant to amend their policies procedures or systems as payments using the card details can be processed as normal debit or credit card transactions.
The system/service is highly secure since the registration procedure can take account of the identity of the mobile telephony device, a passcode provided by the user and the address of the user
PIN Block 3DES encryption is used for the communication with the user
LTS encryption system is used for the communication with the user

Various other implementations will of course be possible, and these and other modifications will be apparent to those skilled in the art.

1. An electronic system providing data representing details of a payment card for use in a transaction, comprising a server having:
a first interface for communication with mobile telephony devices over a mobile telephone network; and
a second interface for communication with a card issuing system for issuing data representing details of a payment card in response to the communicated information,
wherein the first interface comprises:
receiving means adapted to receive a request for the data representing details of a payment card from a user operating a mobile telephony device; and
transmitting means adapted to provide the data representing details of a payment card to a mobile telephony device,
and wherein the second interface comprises:
transmitting means adapted to transmit information to the card issuing system based on the request; and
receiving means adapted to receive data representing details of a payment card from the card issuing system.

2. A system as claimed in claim 1, wherein the first interface is for communication with a SIM card and a mobile software application of a mobile telephony device.

3. A system as claimed in any preceding claim, wherein the first interface includes a personal identification number or password security system.

4. A system as claimed in claim 3, wherein the first interface includes PIN Block 3DES encryption.

5. A system as claimed in any preceding claim, wherein the first interface further includes a lightweight transport security encryption system.

6. A system as claimed in any preceding claim, further comprising a database storing information relating to users of the system.

7. A system as claimed in any preceding claim, wherein the system implements a security verification process by verifying at least one of: the identity of a user of a mobile telephony device; the identity of the mobile telephony device [SIM/MSISDN]; a passcode or password provided by the user; and a bank account identifier set by a banking organisation.

8. A system as claimed in claim 7, wherein the system is further adapted to verify a bank account personal identification number agreed with the banking organisation.

9. A system as claimed in any preceding claim wherein the information transmitted to the card issuing system comprises information relating to at least one of: the identity of a user of a mobile telephony device; details relating to the identity of the mobile telephony device; and a passcode provided by the user;
requested fund amount; type of currency; and requested expiry date.

10. A mobile telephone network, comprising:
a system as claimed in any preceding claim; and
a plurality of user mobile telephony devices,
wherein the system is arranged to communicate with at least one banking organisation.

11. A mobile telephone network as claimed in claim 10, wherein the server is arranged to act as a gateway to banking records of at least one banking organisation.

12. A mobile telephone network as claimed in claim 10 or 11, wherein the card issuing system is arranged to act as a gateway to banking records of at least one banking organisation.

13. A mobile telephone network as claimed in any of claims 10 to 12, wherein the user mobile telephony devices are operable to request data representing details of a payment card for use in a transaction.

14. A method of requesting data representing details of a payment card for use in a transaction, the method comprising the steps of:
receiving a request for the data from a user operating a mobile telephony device, the user selecting options provided to the user by the mobile telephony device; and
processing the request and communicating information to an issuing system for issuing data representing details of a payment card in response to the data request.

15. A method as claimed in claim 14, wherein the information communicated to the card issuing system comprises information relating to at least one of: the identity of a user of a mobile telephony device; details relating to the identity of the mobile telephony device; and a passcode provided by the user; requested fund amount; type of currency; and requested expiry date.

16. A method as claimed in claim 15, wherein the step of processing the request comprises verifying at least one of: the identity of a user of a mobile telephony device; details relating to the identity of the mobile telephony device;
and a passcode provided by the user.

17. A method as claimed in claim 15 or 16, wherein the step of processing the request comprises verifying a bank account personal identification number agreed with a banking organisation.

18. A method as claimed in any of claims 14 to 17, wherein PIN Block 3DES encryption is used for communication with the user.

19. A method as claimed in any of claims 14 to 18, wherein an LTS encryption system is used for the communication with the user.

20. A method of generating data representing details of a payment card for use in a transaction, the method comprising the steps of:
receiving from an intermediary information comprising user data including mobile telephony identification data; and
generating data representing details of a payment card based on the user data.

21. A method as claimed in claim 20, wherein the data representing details of a payment card comprises user identification data.

22. A method of supplying data representing details of a payment card for use in a transaction, the method comprising the steps of:
communicating the data from a card issuing system to a server having an interface for communication with a user telephony device over a mobile network; and
transmitting the data over the mobile telephony network to a user operating a mobile telephony device.

23. A method as claimed in claim 22, wherein PIN Block 3DES encryption is used for the transmission of data between the server and the user.

24. A method as claimed in claim 22 or 23, wherein an LTS encryption system is used for the transmission of data between the server and the user.

25. A method of providing data representing details of a payment card for use in a transaction, the method comprising the steps of:
requesting the data according to the method of any of claims 14 to 19;
generating the data according to the method of claim 20 or 21; and
supplying the data according to the method of any of claims 22 to 24.

26. An electronic system providing data representing details of a payment card for use in a transaction, comprising a server having:
a first interface for communication with user mobile telephony devices over a mobile telephone network; and
a second interface for communication with a card issuing system for issuing data representing details of a payment card in response to the communicated information,
wherein the first interface is adapted to allow requests for data representing details of a payment card to be submitted to the card issuing system and to provide data representing details of a payment card to a user of a mobile telephony device.
